(19) United States
(12) Patent Application Publication
(10) Pub. No.: US 2024/0281817 A1
(43) Pub. Date: Aug. 22, 2024

(54) VERIFYING ITEMS IN A SHOPPING CART BASED ON WEIGHTS MEASURED FOR THE ITEMS

(71) Applicant: Maplebear Inc. (dba Instacart), San Francisco, CA (US)

(72) Inventors: Michael Joseph Sanzari, New York, NY (US); Graham Beauregard, Burlington (CA); Griffin Kelly, Chicago, IL (US)

(21) Appl. No.: 18/172,956

(22) Filed: Feb. 22, 2023

(51) Int. Cl. G06Q 20/40; B62B 3/14; B62B 5/00; G06Q 20/20; G06V 10/70; G06V 20/64

(52) U.S. Cl. CPC G06Q 20/4016; B62B 3/1424; B62B 5/0096; G06Q 20/208; G06V 10/70; G06V 20/64

(57) ABSTRACT

An automated checkout system accesses an image of an item inside a shopping cart and receives an identifier determined for the item inside the cart. The automated checkout system determines a load measurement for the item inside the cart using load sensors coupled to the cart. The automated checkout system encodes a feature vector of the item based at least on the determined weight, the accessed image, and the determined identifier. The automated checkout system inputs the feature vector to a machine-learning model to determine a confidence score describing a likelihood that the identifier determined for the item matches the item placed inside the cart. If the confidence score is less than a threshold confidence score, the automated checkout system generates a notification alerting an operator of an anomaly in the identifier.

### BACKGROUND

This disclosure relates generally to a computer-implemented item recognition system and more particularly to a machine-learning model trained to verify identities predicted for items within the shopping cart.

Traditional brick-and-mortar stores with human attendants and cashiers generally provide shopping carts and/or baskets to users for use in holding items to be purchased. When ready to checkout, the users present their items to a human cashier who manually scans each and every item. Automated checkout systems allow a customer at a brick-and-mortar store to complete a checkout process for items without aid from a human attendant. However, existing automated checkout systems are susceptible to situations where the automated checkout system identifies one item but the customer places another item in the shopping cart. For example, conventional automated checkout systems implement computer vision techniques to identify items in a shopping cart from images of the cart. However, the computer vision may identify an item placed in a cart as a first item, but the item is actually a different, more expensive item. As an alternative, an automated checkout system may prompt a customer to manually scan each item, but the customer may spoof the system by placing a second, more expensive item in the shopping cart.

### SUMMARY

In accordance with one or more aspects of the disclosure, an automated checkout system uses a shopping cart including multiple load sensors that measure the weight of its storage area or original items placed within the storage area. The load sensors of the shopping cart continuously record load data measurements and label each measurement with a timestamp describing when the measurement was recorded. When a customer places an item in the shopping cart, the automated checkout system determines an identifier for the item, for example via a customer input or image data captured for the item and records a timestamp describing when the identifier was determined. After identifying the item, the automated checkout system accesses load data describing when the item was recorded.

The automated checkout system inputs the accessed load data, image data captured for the shopping cart, and any other attributes of the identified item and the environment surrounding the shopping cart to a machine-learning model (referred to herein as an “item verification model”) to verify that the identified item matches the item placed in the shopping cart. The item verification model outputs a confidence score describing the accuracy of the identifier determined for the item by the automated checkout system. Described differently, the confidence score describes a likelihood that the identifier determined for the item matches the true identity of the item placed in the shopping cart.

To train the item verification model, the automated checkout system accesses a set of labeled training examples. Each training example describes an item added to a shopping cart and is labeled with load data describing load measurements recorded for the item over a series of timestamps as the item is added to and stored within the storage area of the shopping cart. The automated checkout system applies the item verification model to the training examples to predict a confidence in the item identified by the item identification model, thereby verifying the prediction generated by the item identification model. To generate a loss value, the automated checkout system compares the predicted output value to the labels on the training data. The parameters of the item verification model are updated based on the loss and the parameter values are stored for later use in identifying items in a shopping cart.

In one or more embodiments, the automated checkout system accesses an image of an item inside a shopping cart and determines a weight of the item inside the shopping cart based on a load measurement recorded within a threshold timeframe of the identifier being determined. The load measurement is recorded by a load sensor coupled to the cart and is stored with a timestamp describing when the measurement was recorded. The automated checkout system encodes a feature vector of the item based on one or more of the determined weight, the accessed image, and the determined identifier. The automated checkout system inputs the encoded feature vector to a machine-learning model to verify the identifier of the item inside the cart by determining a confidence score describing the accuracy of the identifier determined for the item. If the confidence score is less than a threshold confidence, the automated checkout system generates a notification to a user of the shopping cart identifying an error in the identifier with a request for the user to correct the error.

Accordingly, the item verification model reduces the risk of a customer fraudulently placing items in the shopping cart or accepting an erroneous identification of an item. By verifying the identity of an item using the load measurements recorded by the shopping cart, the automated checkout system prevents a customer from placing an item in the shopping cart that is more expensive or valuable than the item identified in the shopping cart or a quantity of items greater than the number identified by the shopping cart.

### BRIEF DESCRIPTION OF DRAWINGS

FIG. 1 illustrates an example environment of an automated checkout system, in accordance with one or more illustrative embodiments.

FIG. 2 illustrates an example system architecture for an item recognition module, in accordance with one or more embodiments.

FIG. 3 illustrates an example system architecture for an anomaly detection module, in accordance with one or more illustrative embodiments.

FIG. 4 is a flowchart illustrating an example method for verifying the identity of an item in a shopping cart based on a load measurement recorded for the item, in accordance with one or more illustrative embodiments.

FIG. 5A is an illustration of an example shopping cart where an item is placed and a user interface identifying the item, in accordance with one or more illustrative embodiments.

FIG. 5B is an illustration of an example data flow through the item verification model, in accordance with one or more illustrative embodiments.

The figures use like reference numerals to identify like elements. A letter after a reference numeral, such as “104A,” indicates that the text refers specifically to the element having that particular reference numeral. A reference numeral in the text without a following letter, such as “104,” refers to any or all of the elements in the figures bearing that reference numeral.

The figures depict various embodiments for purposes of illustration only. One skilled in the art will readily recognize from the following description that alternative embodiments of the structures and methods illustrated herein may be employed without departing from the principles of the disclosure described herein.

### DETAILED DESCRIPTION

### Example System Environment for Automated Checkout System

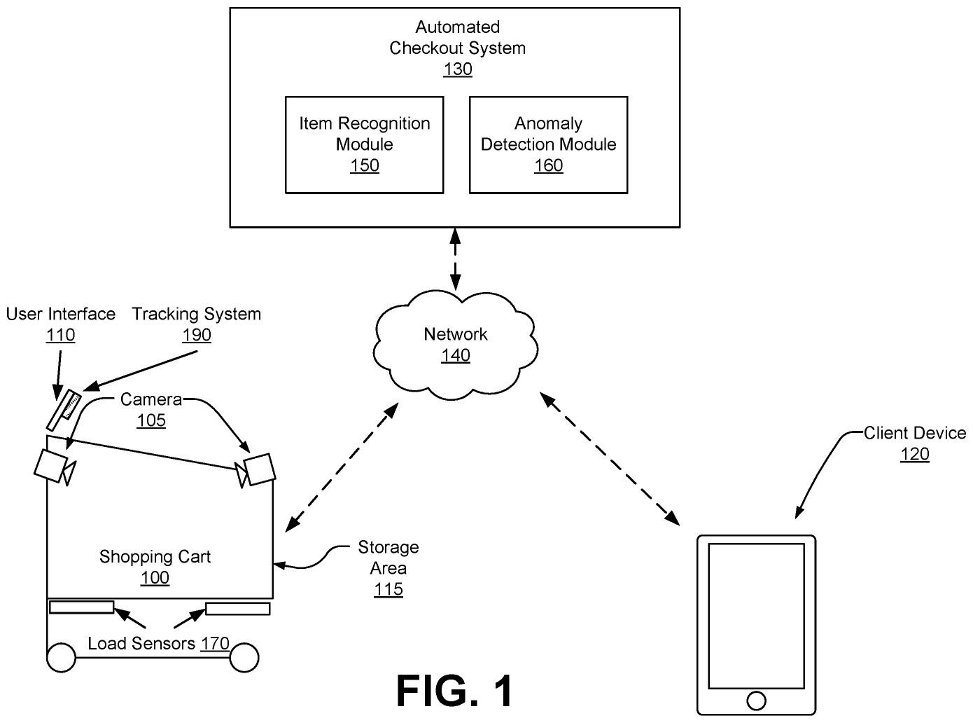

FIG. 1 illustrates an example system environment for an automated checkout system, in accordance with one or more illustrative embodiments. The system environment illustrated in FIG. 1 includes a shopping cart 100, a client device 120, an automated checkout system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in one or more embodiments, by the automated checkout system 130 or the client device 120. Similarly, functionality described below as being performed by the automated checkout system 130 may, in one or more embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface 110 that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In one or more embodiments, the cameras 105 include embedded processing capabilities to process image data captured by the cameras 105. For example, the cameras 105 may be mobile industry processor interface (MIPI) cameras.

In one or more embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the automated checkout system 130.

The one or more load sensors 170 capture load data for the shopping cart 100. In one or more embodiments, the one or more load sensors 170 may be scales that detect the weight (e.g., the load) of the content in the storage area 115 of the shopping cart 100. The load sensors 170 can also capture load curves-the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 includes a user interface 110 through which the user can interact with the automated checkout system 130. The user interface 110 may include a display, a speaker, a microphone, a keypad, or a payment system (e.g., a credit card reader). The user interface 110 may allow the user to adjust the items in their shopping list or to provide payment information for a checkout process. Additionally, the user interface 110 may display a map of the store indicating where items are located within the store. In one or more embodiments, a user may interact with the user interface 110 to search for items within the store, and the user interface 110 may provide a real-time navigation interface for the user to travel from their current location to an item within the store. The user interface 110 also may display additional content to a user, such as suggested recipes or items for purchase.

The shopping cart 100 may include one or more wheel sensors (not shown) that measure wheel motion data of the one or more wheels. The wheel sensors may be coupled to one or more of the wheels on the shopping cart. In one or more embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes a tracking system 190 configured to track a position, an orientation, movement, or some combination thereof of the shopping cart 100 in an indoor environment. The tracking system 190 may be a computing system comprising at least one processor and computer memory. The tracking system 190 may further include other sensors capable of capturing data useful for determining position, orientation, movement, or some combination thereof of the shopping cart 100. Other example sensors include, but are not limited to, an accelerometer, a gyroscope, etc. The tracking system 190 may provide real-time location of the shopping cart 100 to an online system and/or database. The location of the shopping cart 100 may inform content to be displayed by the user interface 110. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the automated checkout system 130 through a client device 120. The client device 120 can be a personal or mobile computing device, such as a smartphone, a tablet, a laptop computer, or desktop computer. In one or more embodiments, the client device 120 executes a client application that uses an application programming interface (API) to communicate with the automated checkout system 130 through the network 140. The client device 120 may allow the user to add items to a shopping list and to checkout through the automated checkout system 130. For example, the user may use the client device 120 to capture image data of items that the user is selecting for purchase, and the client device 120 may provide the image data to the automated checkout system 130 to identify the items that the user is selecting. The client device 120 may adjust the user's shopping list based on the identified item. In one or more embodiments, the user can also manually adjust their shopping list through the client device 120.

The automated checkout system 130 allows a customer at a brick-and-mortar store to complete a checkout process in which items are scanned and paid for without having to go through a human cashier at a point-of-sale station. The automated checkout system 130 receives data describing a user's shopping trip in a store and generates a shopping list based on items that the user has selected. For example, the automated checkout system 130 may receive image data from a shopping cart 100 and may determine, based on the image data, which items the user has added to their cart. When the user indicates that they are done shopping at the store, the automated checkout system 130 facilitates a transaction between the user and the store for the user to purchase their selected items. As noted above, while the automated checkout system 130 is depicted in FIG. 1 as separate from the shopping cart 100 and the client device 120, some or all of the functionality of the automated checkout system 130 may be performed by the shopping cart 100 or the client device 120, and vice versa. Although the automated checkout system 130 is described herein with reference to a shopping cart, the automated checkout system 130 may be mounted in any suitable retail environment, for example a kiosk or checkout counter.

The automated checkout system 130 establishes a session for a user to associate the user's actions with the shopping cart 100 to that user. The user may establish the session by inputting a user identifier (e.g., phone number, email address, username, etc.) into a user interface 110 of the shopping cart 100. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In one or more embodiments, the automated checkout system 130 establishes a session between a user and a shopping cart 100 automatically based on sensor data from the shopping cart 100 or the client device 120. For example, the automated checkout system 130 may determine that the client device 120 and the shopping cart 100 are in proximity to one another for an extended period of time, and thus may determine that the user associated with the client device 120 is using the shopping cart 100.

The automated checkout system 130 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. As illustrated in FIG. 1, the automated checkout system 130 comprises an item recognition module 150 and an anomaly detection module 160.

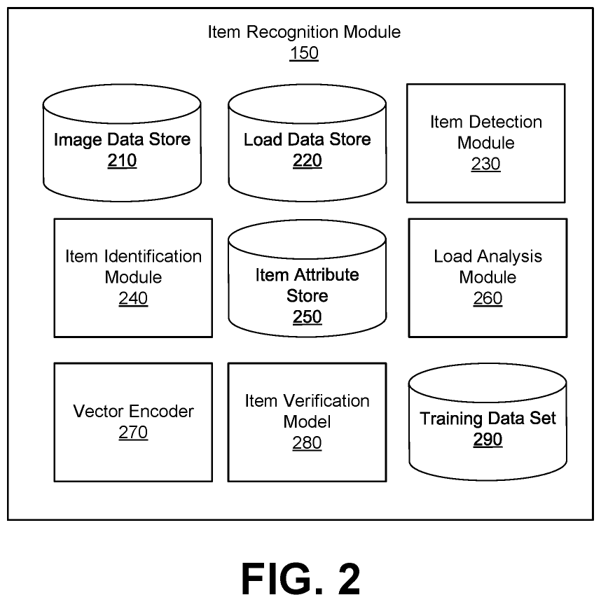

The item recognition module 150 identifies items the user places in their shopping cart. To generate the shopping list, the item recognition module 150 analyzes image data captured by the cameras 105 on the shopping cart 100 and load data captured by the load sensor 170 on the shopping cart 100. In addition, the item recognition module 150 verifies identity recorded for an item based on load data, visual features, or a combination thereof. In one or more embodiments, the automated checkout system 130 verifies the identity of an item added to the cart 100 by applying a machine-learning model (e.g., a neural network) to load data recorded by the load sensors 170. The machine-learning model outputs a confidence score in the identity determined for an item based on a comparison of a load measurement recorded for the item and previously recorded and verified load measurements recorded for the same or adjacent items. The confidence score and the item recognition module 150 are further described below with reference to FIG. 2.

In addition to the techniques described herein, the item recognition module 150 may identify items in the storage area 115 of the shopping cart 100 using any suitable technique. In one or more embodiments, the item recognition module 150 receives inputs from the user of the shopping cart 100 identifying an item placed in the storage area 115 of the shopping cart 100. For example, a user may manually enter an identifier of the item via the user interface 110 or select an identifier of the item via a menu displayed on the user interface 110. In another embodiment, the user scans the barcode on an item, for example via a barcode sensor on the shopping cart 100 (not shown), and the item recognition module 150 identifies the item based on the scanned barcode.

Additionally or alternatively, the item recognition module 150 applies a barcode detection model to images of items captured in the shopping cart 100 to identify and scan barcodes on items in the storage area 115. The barcode detection model is a machine-learning model trained to identify items by identifying barcodes on the items based on image data captured by the cameras 105. The barcode detection model identifies portions of the image data that correspond to a barcode on an item and determines the identifier for the item (e.g., the SKU number) represented by the barcode.

Additionally or alternatively, the item recognition module 150 uses an image recognition model to identify items in the shopping cart's storage area. The image recognition model is a machine-learning model that is trained to identify items based on visual characteristics of the items captured in the image data from the cameras 105. The image recognition model identifies portions of the image that correspond to each item and matches the item to a candidate item within the store. The item recognition module 150 may additionally filter candidate items within the store based on the location of the shopping cart within the store determined by the tracking system 190 and a known or anticipated location of each candidate item within the store.

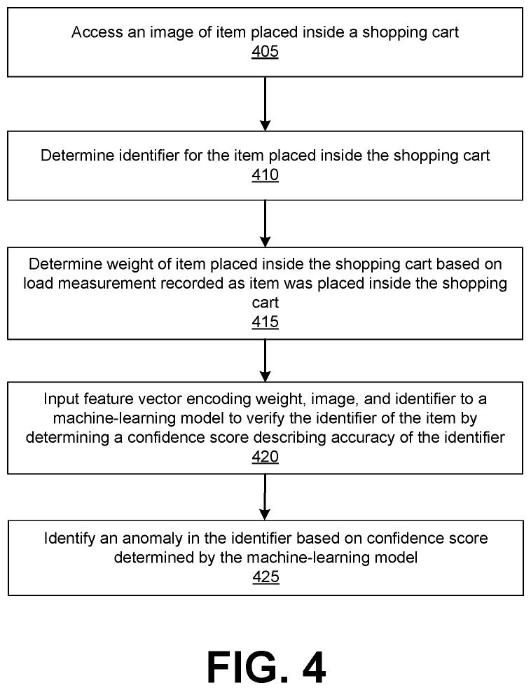

The anomaly detection module 160 identifies anomalies in the identification of items based on the confidence score determined by the item recognition module 150. As described herein, anomalies refer to discrepancies between the identifier determined for an item (whether recorded by a user or determined by the automated checkout system) and the actual identity of the item. An anomaly may occur due to incorrect prediction by the item recognition module 150 or due to an unintentional error by the user when recording the item at the user interface 110. Alternatively, an anomaly may occur where a user intentionally records an identifier of one item at the user interface but places a different item in the shopping cart. Such intentional errors are also referred to as “fraudulent instances.” In one or more embodiments, the anomaly detection module 160 generates an alert of possible fraud if the confidence score falls outside a range of load measurements previously recorded for the item. In another embodiment, the anomaly detection module 160 determines an acceptable variance in load measurements recorded for the item and generates an alert of possible fraud if the load measurement recorded for the identified item falls outside the acceptable variance. The anomaly detection module 160 is further described below with reference to FIG. 4.

The automated checkout system 130 facilitates a checkout by the user through the shopping cart 100. The automated checkout system 130 computes a total cost to the user of the items in the user's shopping list and charges the user for the cost. The automated checkout system 130 may receive payment information from the shopping cart 100 and uses that payment information to charge the user for the items. Alternatively, the automated checkout system 130 may store payment information for the user in user data describing characteristics of the user. The automated checkout system 130 may use the stored payment information as default payment information for the user and charge the user for the cost of the items based on that stored payment information.

In one or more embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

The shopping cart 100 and client device 120 can communicate with the automated checkout system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In one or more embodiments, the network 140 may include Bluetooth or near-field communication (NFC) technologies or protocols for local communications between computing devices. The network 140 may transmit encrypted or unencrypted data.

### Example System Architecture for an Item Recognition Module

In some circumstances, the item recognition module 150 may determine an identifier for a first item but the user of the shopping cart may place a second, different item into the cart. For example, a user may scan a barcode for a loaf of bread while placing a carton of milk in the shopping cart. Accordingly, the automated checkout system 130 updates the shopping list for the user with a loaf of bread and the price of the loaf of bread, but the user placed a more expensive carton of milk in the shopping cart. As another example, the automated checkout system 130 may identify an item as a single bottle of a beverage when the actual item is a package containing six bottles of the beverage. Such errors whether made intentionally or unintentionally by the user or erroneously by the automated checkout system 130 result in the user purchasing items for less than their actual value.

Accordingly, the item recognition module 150 implements a machine-learning model to verify the identity of an item recorded by the automated checkout system 130 based, at least in part, on load data recorded by the load sensors 170. The machine-learning model, also referred to as an item verification model, determines a confidence that the identity of an item recorded by the automated checkout system 130 matches the actual identity of the item. The item recognition module 150 inputs the load data recorded when the item was placed in the storage area 115, images captured of the storage area 115 during that time, and the other attributes of the item and the environment surrounding the shopping cart 100 to the machine-learning model, which outputs a confidence that the item identified by the automated checkout system 130 matches the item actually placed in the shopping cart.

FIG. 2 illustrates an example system architecture for an item recognition module 150, in accordance with one or more illustrative embodiments. The item recognition module 150 includes an image data store 210, a load data store 220, an item detection module 230, an item identification module 240, an item attribute store 250, a load analysis module 260, a vector encoder, an item verification model 280, and a model training data set 290. Computer components such as web servers, network interfaces, security functions, load balancers, failover servers, management and network operations consoles, and the like are not shown so as to not obscure the details of the system architecture. Alternative embodiments may include more, fewer, or different components from those illustrated in FIG. 2, and the functionality of each component may be divided between the components differently from the description below.

The image data store 210 stores image frames received from the one or more cameras 105. As described above, the cameras 105 capture images of the storage area 115 of the shopping cart 100. Depending on the orientation and configuration of the cameras 105, the image frames capture images of different portions of the storage area 115 and items positioned in the different portions of the storage area 115. The images stored in the image data store 210 include metadata that describes which camera 105 captured each image. Additionally, each image may include a timestamp of when the image was captured by the camera 105.

The load data store 220 stores load sensor data received from the one or more load sensors 170. The load data includes metadata about which load sensor 170 captured each measurement. In some embodiments, the metadata may specifically identify the load sensor 170. For example, each measurement of the load data may be associated with an identifier for the load sensor that captured the measurement of the set of measurements. Alternatively, the load data store 220 may organize load data such that load data from a particular load sensor can be implicitly identified based on the positioning of the load data in the structure. For example, the load data may be concatenated into a large set of load data, and the load data from a load sensor is positioned in the concatenation based on a predetermined ordering of the load sensors. In some embodiments, an embedding may be generated for a set of load data from each load sensor, and the embeddings may be concatenated according to a predetermined ordering of the load sensors. Additionally, each measurement of the load sensor data may include a timestamp describing when the data was captured by the load sensor 170. The load data store 220 may organize load data measurements into a time series based on the timestamps at which each measurement was recorded. Such a time series may be referred to as a load curve.

The item detection module 230 detects that an item has been added to the shopping cart 100 (or removed from the cart). In one or more embodiments, the item detection module 230 may detect that an item has been added to the shopping cart 100 using inputs from sensors on the shopping cart 100. In one or more embodiments, the item detection module 230 uses trained machine learning models from the model store to predict that an item has been added or removed from the shopping cart 100. In some embodiments, the item detection module 230 uses information from the image data received from the cameras 105 that movement has been detected in the shopping cart 100 to determine that an item has been moved into or out of the cart. Similarly, in some embodiments, the item detection module 230 may use information from the load sensors, such as a detected change in load of the contents of the shopping cart 100, to determine that an item has been added to or removed from the shopping cart 100. In alternative embodiments, the shopping cart 100 may include additional sensors, such as accelerometers or laser sensors that can be triggered by items being moved into the shopping cart 100.

When the item detection module 230 receives a trigger and determines that an item has been added to the shopping cart 100, the item detection module 230 determines a threshold timeframe that should be used by the automated checkout system 130 to identify the item. In one or more embodiments, the item detection module 230 may identify a threshold timeframe that begins some predetermined amount of time before the item detection occurred and that ends some predetermined amount of time after the item detection occurred. For example, if the item detection module 230 determines that an item has been added to the shopping cart at time t0 the item detection module 230 may then determine that data recorded within a threshold timeframe of 200 milliseconds before t0 and 200 milliseconds after t0 should be considered when identifying the item. In another embodiment, the item detection module 230 may use images and load data received when the item was detected as inputs to a machine learning model that determines how broad the time range for providing further image and load data to item identification models should be (e.g., a timestamp detection model that identifies a set of timestamps that are most likely to correspond to the item being placed in the storage area of the shopping cart 100). The threshold timeframe determined by the item detection module 230 makes it possible for the automated checkout system 130 to analyze only input data that is important for predicting the identity of an item, rather than analyzing all input data as it is received.

The item identification module 240 determines an identity of an item that a user either has placed or is about to place into the shopping cart. In some embodiments, the item identification module 240 receives a manual entry from the user of the shopping cart 100. For example, the user may manually enter an identifier of the item via the user interface 110 (e.g., a SKU or name and brand of the item). As another example, a user may manually select an identifier of the item from a list of items via the user interface 110 (e.g., a series of drop down menus). In another embodiment, the user scans the item (e.g., scans a barcode on the item) before adding the item to the cart 100. In such embodiments, the item identification module 240 may reference a lookup table stored at the item attribute store 250 to determine an identifier of the item. The item attribute store 250 is further described below.

In some embodiments, the item identification module 240 applies a trained machine-learning model to predict the identity of an item from an image captured by the cameras 105. Such an item identification model identifies the item based on visual features extracted from the image. In particular, the item identification model 240 analyzes features extracted for the item to determine similarity scores between the item and one or more candidate items. International Application No. PCT/CN2022/0127935, filed Oct. 27, 2022, describes an image-based item identification model in further detail and is incorporated by reference herein in its entirety.

The item attribute store 250 maintains a record of each item available within a given store. Each item is labeled with a unique identifier of the item (e.g., a SKU number). The item attribute store 250 may additionally store one or more images of the item labeled with the unique identifier of the item and a known location of the item within the store. For example, where the item is a particular bag of chips, the item attribute store 250 stores one or more images of that particular bag of chips with a label comprising a unique identifier for that particular bag of chips and the aisle of the store where that particular bag of chips may be found. In one or more embodiments, the item attribute store 250 may additionally store features of an item extracted from labeled images of the item (e.g., color, shape, texture, etc.). Depending on the inventory preferences of a store, the item attribute store 250 may define items at varying levels of granularity. For example, the item attribute store 250 assigns different brands of the same item (e.g., different brands of potato chip) different unique identifiers and relates the unique identifier to images of the particular brand of item and the location of the particular brand of item. As another example, one brand may offer different sizes or varieties of the same item. Accordingly, the item attribute store 250 assigns each size or variety of the item (e.g., different sized bags of the same brand of potato chip) with a unique identifier and relates the unique identifier to images of the particular variety and the location of the particular variety.

Information within the item attribute store 250 may be stored in lookup tables indexed by the unique identifiers. For example, each row of the lookup table may include the unique identifier of an item, labeled images of the item, features extracted from the labeled images of the item, the location of item within the store, or a combination thereof. The item attribute store 250 may be updated at periodic intervals or in response to a trigger event, for example a new image of an item captured by the cameras 105. Such periodic updates ensure that the item attribute store 250 stores the most recent (or updated) images of a content and reflect the most up-to-date offerings within the store.

The item identification module 240 identifies an item placed in the shopping cart using any of the techniques described above. However, because items may be incorrectly identified by the item identification module 240 or fraudulently recorded by a user, the load analysis module 260 uses load data measurements recorded within a threshold timeframe of the item's identification by the automated checkout system. As described above, load data stored in the load data store 220 is labeled with a timestamp describing a time when the measurement was recorded. The load analysis module 260 accesses the threshold timeframe determined by the item detection module 230 (as described above) and identifies a load measurement recorded within the threshold timeframe. The identified load measurement characterizes the weight of the identified item. Accordingly, the load analysis module 260 assigns the identified weight to the identified item to be used by the item verification model 280 to verify the identity of the item.

In some embodiments, the load sensors 170 continuously collect the load data for the entire cart and model fluctuations in the weight of the cart as a continuous curve. In other embodiments, the load sensors 170 periodically collect load data for the entire cart in response to a trigger event, for example the identification of an item or the placement of an item in the storage area 115. The load analysis module 260 determines a load measurement for the identified item based on the difference between the assigned load measurement and the immediately preceding load measurement.

The threshold timeframe extends backwards from the timestamp when the item was identified to account for circumstances where the user places the item in the shopping cart before manually identifying the item and circumstances where the item is identified from images captured by the cameras 105. Additionally, the threshold timeframe extends forward from the time stamp when the item was identified to account for circumstances where the user places the item in the shopping cart after manually identifying the item.

In some embodiments, a user may place multiple items in the shopping cart during the threshold timeframe. In such embodiments, the load analysis module 260 may select the load measurement recorded nearest to the timestamp when the item was identified. For example, if a first load measurement was recorded 30 seconds before the item was identified and a second load measurement was recorded 15 seconds before the item was identified, the load analysis module 260 may retrieve the second load measurement for verifying the identified item. The load analysis module 260 may additionally consider whether multiple items were identified during the threshold timeframe and generate a queue of identified items. If such a queue exists, the load analysis module 260 assigns each weight recorded during the timeframe to an item in the queue. For example, if three items were identified within the threshold timeframe and a first load measurement was recorded 45 seconds before the item was identified, a second load measurement was recorded 15 seconds after, and a third load measurement was recorded 15 seconds after that, the load analysis module 260 assigns the first load first measurement to the first identified item, the second load measurement to the second item, and the third load measurement to the third item.

Additionally, the load analysis module 260 may access previously recorded load measurements stored in the load data store 220 and confirm whether the load measurement assigned to an identified item is within a threshold deviation of the previously recorded load measurements. In such embodiments, the load analysis module 260 may determine an average of the previously recorded load measurements and compare the average to the assigned load measurement.

The vector encoder 270 encodes the assigned load measurement and previous load measurements stored in the load data store 220 for the identified item into a feature vector. As described herein a feature vector is a representation of the assigned load measurement, which may be processed by a machine-learning model (e.g., the item verification model 280) to verify the identity of the item. In some embodiments, the vector encoder extracts visual features of images of the item captured by the camera 105 and also encodes the extracted features into a feature vector. Examples of visual features extracted for an item include, but are not limited to, size of the item, shape of the item, color of the item, etc. The vector encoder 270 encodes a feature vector for the item based on the extracted visual features.

In some embodiments, the load data store 220 does not store previously recorded load data for the identified item. In such embodiments, the feature vector encoder 270 may access previously recorded load data for a related item, also referred to as an adjacent item. An adjacent item is a different item that shares physical qualities with the identified item, for example type of product, size of item, weight of item, etc. The load data store 220 may store relationships between items in a store that are known to be similar or adjacent to each other. For example, adjacent items may have similar SKU numbers (e.g., SKUs that only differ by a single digit), be similarly titled or similarly priced, have a similar barcode, or be positioned within a vicinity of each other (e.g., located on the same shelf), have any other suitable characteristic in common, or a combination thereof. For example, the load data store 220 may store a relationship between different brands of bananas given their similar SKU numbers. As another example, the load data store 220 may store a six-pack of soda as related to a six-pack of an energy drink because of their similar location within the store and their similar prices. Relationships between adjacent items may be defined or assigned manually by an operator or extracted from historical data including shopping lists and checkouts by previous users.

As described above, the item recognition module 150 applies machine-learning techniques to verify whether an identifier determined for an item matches the true identity of the item based on load data collected for the item. In particular, the item verification model 280 analyzes the load measurement assigned to the identified item and the previously recorded load data for the identified item or an adjacent item to determine a confidence score for the identifier of the item. As described herein, the confidence score describes an accuracy of the identifier determined for an item placed in the shopping cart. Described differently, the confidence score represents a likelihood that the identifier of an item matches the true identity of the item. The item verification model 280 may be a mathematical function or another more complex logical structure, trained using a combination of features stored in the model training data set 290 to determine a set of parameter values stored in advance and used as part of the verification analysis. As described herein, the term “model” refers to the result of the machine learning training process. Specifically, the item verification model 280 describes the function for determining a confidence in the identification of an item and the determined parameter values incorporated into the function. “Parameter values” describe the weight associated with at least one of the features of the encoded feature vector.

To determine the confidence score for the identification by the item detection module 230, the item verification model 280 begins by generating a weight range for the identified item based on the previously recorded load data encoded into the feature vector. Because the weight of an item may fluctuate due to changes in packaging and/or the volume of the item, the previous recorded load data represents a range of weights measured for the identified item. In embodiments where the load data store 220 does not contain previously recorded load data for the identified item, the feature vector is encoded with previously recorded load data for one or more adjacent items.

Next, the item verification model 280 determines whether the load measurement assigned to the identified item falls within the determined weight range. In some embodiments, the confidence score is a binary value describing whether the load measurement falls within or beyond the determined weight range. In other embodiments, the confidence score is a non-binary value. In such embodiments, the item verification model 280 may determine a higher confidence score for a load measurement that falls within the weight range compared to a load measurement that does not fall within the weight range. In some embodiments, the item verification model 280 may adjust the confidence score based on where it falls within the weight range. For example, the item verification model 280 may determine a higher confidence score for a weight measurement that falls near the middle of the weight range than a weight measurement that falls near either edge of the weight range.

In some embodiments, the feature vector encoder 270 may additionally encode one or more additional features of the item into the feature vector input to the item verification model 280. As described above, the item attribute store 250 stores features of the identified item, for example color, shape, size, and location. In addition to the load measurements described above, the item verification model 280 may determine the confidence score by comparing visual features of the identified item extracted from images of the item to the visual features stored in the item attribute store 250. For example, the item verification model 280 may determine a lower confidence score if the identified item is a banana but visual features extracted from an image of the item show that the item is actually orange than if visual features extracted from the image showed that the item was yellow. The item verification model 280 may also compare features of the identified item to properties of the shopping cart, for example location. For example, item verification model 280 may predict a lower confidence score if the identified item is an apple but the shopping cart is located in the dairy aisle of the store than if the shopping cart were located in the produce section.

The item verification model 280 is trained using the training data set 290, which is made up of a large number of items labeled with a known identity of the item and weight measurements and features extracted from the labeled items. Each entry of the training data set 290 represents an item labeled with a known identification of the item, which may also be referred to as an “identification label.” In one or more embodiments, the training data set 290 is specific to a particular store; the training data set 290 may only store labeled features for items available in that particular store. In other embodiments, the training data set 290 includes labeled features for a variety of items including those that are not currently available in the store but may become available in the future. The item verification model 280 may predict items that may become available in the future based on known relationships between various items, for example as described above. An entry in the training data set may further comprise features of the labeled item, for example load measurement, color, shape, size, or any other feature that contributed to the identification label of the item. To generate a loss value, the automated checkout system compares the predicted identification of the item to the labels on the training data. During training, the item verification model 280 determines parameter values for each feature input to the item verification model 280 by analyzing and recognizing correlations between the features associated with an item (e.g., load measurements) and the identification label of the item. The parameters of the item verification model are updated based on the loss and the parameter values are stored for later use in identifying items in a shopping cart.

As the confidence scores output by the item verification model 280 are verified by operators associated with the store or customers, the training data set 290 may be continuously updated with entries pertaining to newly listed items. In addition, the training data set 290 may be continuously updated as the weights of certain items change, for example due to changes in packaging or sizes of the item. Accordingly, the item verification model 280 may be iteratively trained based on the updated data in the training data set 290 to continuously improve the accuracy of identifications output by the item verification model 280.

In some embodiments, the item verification model 280 may be trained on training data for individual items or a particular category of items to generate a baseline model for the item or category of items. Depending on the item identified by the item identification module 240, the item verification model 280 may select a particular baseline model. For example, if the identified item is a banana, the item verification model 280 may select the baseline model for bananas (or the category “fruits”) and input the encoded feature vector to the selected baseline model. In such embodiments, the baseline model may be further trained using a particularized training data set comprising training data for the particular category of items. Accordingly, a baseline verification model may be further trained to determine a confidence score for a particular item or category of items.

Periodically, the training data set 290 may be updated with entries of novel items or novel features extracted from items already labeled and stored in the training data set 290. Accordingly, item verification model 280 may be iteratively trained by inputting the features of the existing and novel items such that the model 280 continues to learn and refine its parameter values based on the new and updated data set 290. Iteratively re-training the item verification model 280 in the manner discussed above allows the model 280 to more accurately determine confidence scores of an item's identification based on load measurements recorded for the item.

### Example System Architecture for an Anomaly Detection Module

In some circumstances, the automated checkout system module 150 or the user may incorrectly identify an item placed within the cart. Accordingly, the item recognition module 150 verifies the recorded identity of an item based on load measurements collected for the item. Additionally, in some instances, the user may intentionally misidentify the item to deceive the automated checkout system 130 by placing a different, more valuable item in the cart. In such instances, the automated checkout system 130 identifies the identification and the user as fraudulent, for example a more severe anomaly classification. Accordingly, the anomaly detection module 160 analyzes the discrepancy in the identifier determined for an item and the item's true identity based on load measurements previously collected for the item and classifies the identification as either anomalous or fraudulent.

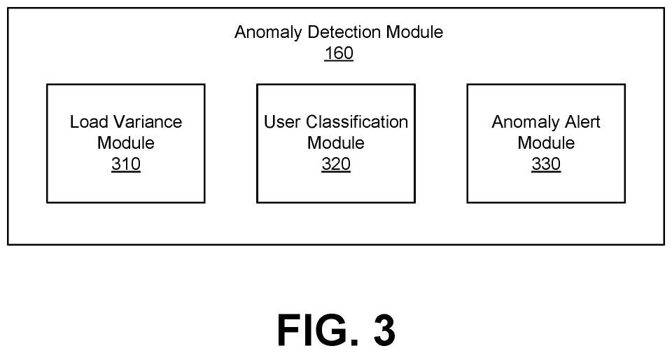

FIG. 3 illustrates an example system architecture for an anomaly detection module 160, in accordance with one or more illustrative embodiments. The anomaly detection module 160 includes a load variance module 310, a user classification module 320, and an anomaly alert module 330. Computer components such as web servers, network interfaces, security functions, load balancers, failover servers, management and network operations consoles, and the like are not shown so as to not obscure the details of the system architecture. Alternative embodiments may include more, fewer, or different components from those illustrated in FIG. 4, and the functionality of each component may be divided between the components differently from the description below.

The load variance module 310 accesses the load data previously recorded for the identified item or one or more adjacent items (as discussed above with reference to FIG. 2) and applies statistical analysis techniques to determine a variance in load data collected for the identified item. The load variance module 310 retrieves previously recorded load data associated with the identified product. The load variance module 310 retrieves previously recorded load data collected for the identified item across multiple sessions, different users, different locations, different retailers, or a combination thereof. The load variance module 310 generates a distribution of load measurements based on the previously recorded load data and computes an acceptable variance of load measurements using any suitable statistical technique. If the confidence score predicted by the item recognition module 150 is below a threshold confidence, the anomaly detection module 160 compares the confidence score to the acceptable variance. The threshold confidence may be defined manually by an operator or determined based on previous confidence scores labeled for fraudulent actions. In one or more embodiments, the threshold confidence is predicted using a machine-learning model trained based on a training dataset of historical confidence scores labeled as pertaining to fraudulent actions.

If the load variance module 310 determines that the confidence score falls within the acceptable variance, the load variance module 310 classifies the anomaly as “an error.” For anomalies classified as “errors,” the anomaly alert module 330 may generate a notification to be displayed to the user via the interface 110 with a prompt for the user to correctly identify the item. Alternatively, the anomaly alert module 330 may generate notification asking if the user intended to record the item as a different item with options of possible correct identifications. In another embodiment, the anomaly alert module 330 may generate a notification alerting an operator within the store of the error. The notification may prompt the operator to review the user's shopping list, correct the error, or cancel the session.

If the load variance module 310 determines that the confidence score is outside the acceptable variance, the load variance module 310 classifies the anomaly as “fraudulent.” In some embodiments, the classification may not be definitive and may require an operator to manually confirm the error as fraudulent. If the operator confirms that the error was fraudulent, the user classification module 320 determines whether the user has a history of fraudulent activity. In other embodiments, the classification may be definitive and prompt the anomaly detection module 160 to consider whether the user has a history of fraudulent activity without any feedback from an operator. To determine whether a user has a history of fraudulent activity, the user classification module 320 may access the user's purchase history including their record of previous fraudulent actions or purchases. If the number of previous fraudulent actions or purchases exceeds a threshold, the user classification module 320 may classify the user as a “fraudulent user.” When a user is classified as a “fraudulent user,” the anomaly alert module 330 may alert an operator associated with the store, the user, or both that the user has a history of fraudulent actions and store the classification. In some embodiments, a fraudulent user may be added to a blocklist stored at the automated checkout system 130. In some embodiments, the anomaly alert module 330 may automatically terminate the user's session upon determining that the user is listed on the blocklist.

In some embodiments, the load variance module 310 may determine a current weight of the shopping cart 100 and correlate the current weight with a current total price of items in the cart. The load variance module 310 may generate a distribution correlating total price with total weight and carts where an anomaly has been identified may be outliers on that distribution. The load variance module 310 may identify such outliers as potentially fraudulent errors.

### Example Implementation of Automated Checkout System

FIG. 4 is a flowchart illustrating an example method for verifying the identity of an item in a shopping cart based on a load measurement recorded for the item, in accordance with one or more illustrative embodiments. The item recognition module 150 accesses 405 an image captured by a camera 105 of an item inside a shopping cart 100. The camera may capture the image in response to a variety of trigger events including, but not limited to, a user placing an item in the shopping cart or the user recording the item at the user interface 110. In one or more embodiments, the captured image contains a single item in the cart. In other embodiments, the captured image contains multiple items in the cart.

Either before or after an item is placed in the shopping cart, the item recognition module 150 determines 410 an identifier for the item. In one or more embodiments, the user manually enters the identifier via a user interface on the cart. In other embodiments, the item recognition module 150 implements one or more of the techniques described above to identify the item based on images captured by the cameras 105. Because the identifier determined for an item may not match the actual identity of the item, the item recognition module 150 verifies the determined identifier using load data collected from load sensors 170 on the cart 100. The item recognition module 150 determines 415 the weight of the item placed inside the shopping cart based on load measurements recorded when or near the time when the item was placed in the shopping cart. Load measurements recorded by the load sensors 170 are assigned timestamps indicating when the measurement was recorded. Accordingly, the item recognition model 150 identifies a load measurement recorded for the item placed in the shopping cart by comparing timestamps of load measurement to a timestamp indicating when the item was connected.

The item recognition module 150 encodes a feature vector including the weight of the identified item (e.g., the identified load measurement), an identifier of the item, an image of the identified item, or a combination thereof. In some embodiments, the encoded feature vector may additionally include visual features of the item extracted from the image, the location of the shopping cart within the store, or a combination thereof. The item recognition module 150 inputs 420 the feature vector to a machine-learning model to verify the identifier of the item by determining a confidence score for the identifier. As described above, the confidence score describes a likelihood that the identifier of the item matches the actual identity of the item. The machine-learning model compares features encoded in the featured vector to labeled features of previous measurements of the item to determine a confidence score between the identifier and the actual item. For example, the item recognition module 150 compares the weight encoded in the feature vector to previous load measurements recorded for the item or adjacent items. The item recognition module 150 may iteratively train the machine-learning model using a training dataset of measurements and features corresponding to labeled items that is periodically updated with new items and new features for existing items. The machine-learning model compares features of the feature vector encoded for the item to labeled measurements features of each candidate item to identify a match between the identifier of the item and the actual item.

If the item recognition module 150 determines the confidence score to be less than a threshold score, the anomaly detection module 160 identifies 425 an anomaly in the identifier based on the confidence score determined by the machine-learning model. In some implementations where the load measurement recorded for the item is within an accepted variance determined for the item, the anomaly is identified as an error and the anomaly detection module 160 prompts the user to correctly identify the item. In other implementations where the load measurement recorded for the item is beyond the accepted variance determined for the item, the anomaly is identified as fraudulent, and the anomaly detection module 160 reports the error to an operator of the store. For fraudulent errors, the anomaly detection module 160 accesses the user's purchase history to generate a record of their previous fraudulent actions. If the number of fraudulent actions exceeds a threshold, the anomaly detection module 160 reports the user as a “fraudulent user” to an operator of the store. In some implementations, the anomaly detection module 160 adds the user to a blocklist associated with the store.

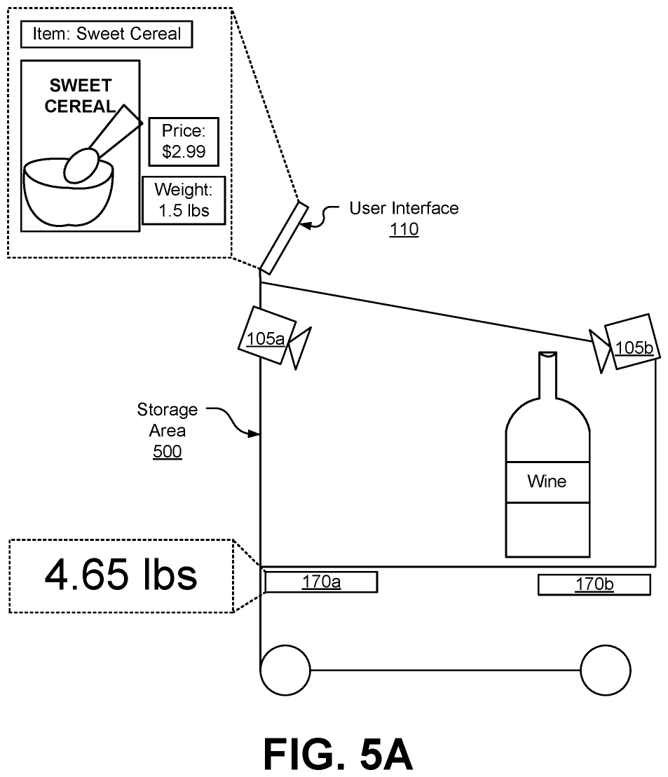

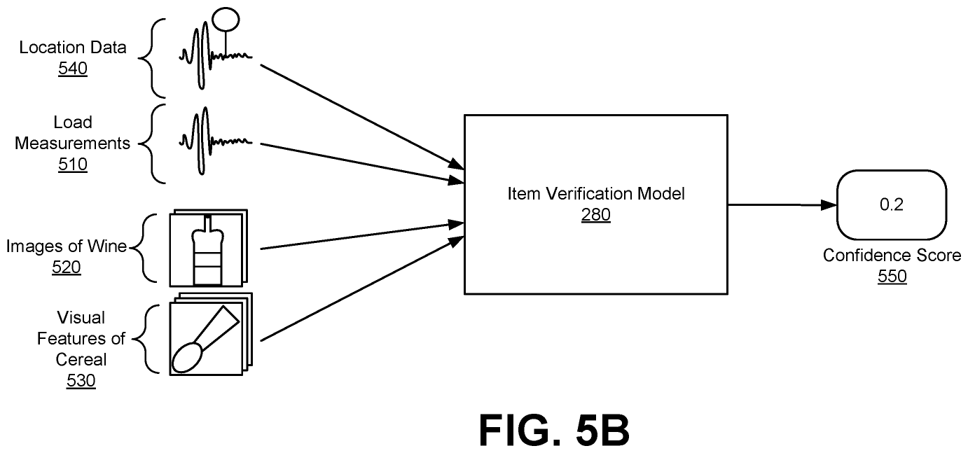

FIG. 5A is an illustration of a shopping cart where an item is placed and a user interface identifying the item, in accordance with one or more illustrative embodiments. Consistent with the description in FIG. 1, the illustrated shopping cart includes a storage area 500, cameras 105a and 105b, load sensors 170a and 170b, and a user interface 110. A user of the shopping cart places a magnum bottle of wine in the storage area 500. The load sensors 170a and 170b measure the weight of items placed in the shopping cart. Accordingly, the load sensors record the weight of the bottle of wine as 4.65 pounds. As described above, a user may identify the item placed in the storage area 500 by manually identifying the item using the user interface 110. However, the user incorrectly identifies the bottle of wine as a different item—a box of cereal. The incorrect identification may be erroneous or fraudulent as described above. However, the identified box of cereal weighs only 1.5 pounds compared to the 4.65 pound bottle of wine actually placed in the storage area 500.

FIG. 5B is an illustration of the data flow through the item verification model, in accordance with one or more illustrative embodiments. Consistent with the description of the item verification model 280 above, the item verification model 280 receives various inputs including, but not limited to, load measurements 510 collected by the load sensors 170a and 170b, images 520 of the bottle of wine, visual features 530 of the identified cereal, and location data describing the location of the shopping cart within the store, or a combination thereof. Based on these inputs, the item verification model 280 generates a confidence score describing a likelihood that the identified item (e.g., the item identified via the user interface 110) matches item placed in the storage area 500. Given the difference in weight between the bottle of wine and the cereal and the difference in their visual features and location within the store, the item verification model 280 determines a confidence score 550 indicating that the two items do not match. In the illustrated embodiment, the confidence score is a binary value where a confidence score of “0” indicates that the item in the storage area 500 does not match the item identified at the user interface 110.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising one or more computer-readable media containing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
accessing an image of an item placed inside a cart;
receiving an identifier for the item placed inside the cart;
determining a load measurement for the item inside the cart, wherein the load measurement is recorded by a load sensor coupled to the cart and is stored with a timestamp describing when the load measurement was recorded;
encoding a feature vector of the item based at least on the determined load measurement, the accessed image, and the received identifier;
inputting the encoded feature vector to a machine-learning model that is trained to compute a confidence score, the confidence score describing a likelihood that the received identifier matches the item placed inside the cart;
determining that the confidence score is less than a threshold confidence; and
generating a notification alerting an operator of an anomaly in the identifier based on the determination that the confidence score is less than the threshold confidence score.

2. The method of claim 1, further comprising:
determining the identifier for the item based on one or more of:
a user input selecting the identifier of the item, wherein the selection of the identifier is made via a graphical user interface on the cart; or
a machine-learning model trained to identify the item by matching the item to a candidate item of a set of candidate items.

3. The method of claim 1, wherein determining the load measurement for the item comprises:
determining a timestamp describing when the identifier for the item was determined;
identifying a plurality of load measurements recorded by the load sensor within a threshold timeframe of the timestamp describing when the identifier was determined; and
identifying a load measurement recorded nearest to the timestamp describing when the identifier for the item was determined based on the timestamp for the identified load measurement.

4. The method of claim 3, wherein identifiers of multiple items were determined during the threshold timeframe, the method further comprising:
generating a queue of items identified during the threshold timeframe, wherein the queue of items are ordered sequentially based on timestamps when the identifier for each item in the queue was received;
identifying a number of load measurements corresponding to a number of items in the queue; and
assigning each of the number of load measurements to an item in the queue sequentially based on the timestamp for the identified load measurement.

5. The method of claim 1, wherein the load measurement for the item inside the cart is determined based on a load measurement recorded within a threshold timeframe of the identifier being determined.

6. The method of claim 1, wherein inputting the encoded feature vector to the machine-learning model to compute the confidence score further comprises:
determining a weight range for the item based on previously recorded load data encoded into the feature vector; and
determining the confidence score based on whether the load measurement falls within the weight range.

7. The method of claim 1, wherein the confidence score is determined by inputting one or more visual features of the item extracted from the accessed image of the item placed in the cart and one or more known visual features of the item associated with the identifier, the method further comprising:
determining the confidence score based on a comparison of the one or more visual features of the item extracted from the accessed image and one or more known visual features for the item associated with the identifier.

8. The method of claim 1, further comprising:
determining an accepted variance in previously recorded load data for the item based on a distribution of the previously recorded load data;
responsive to determining that the confidence score is less than a threshold confidence, comparing the load measurement for the item to the accepted variance; and
responsive to determining the load measurement is outside the accepted variance, transmitting a notification to an operator identifying the anomaly as fraudulent.

9. The method of claim 8, further comprising:
responsive to determining the load measurement is within the accepted variance, transmitting a notification to the operator identifying the anomaly as an error.

10. The method of claim 8, further comprising:
responsive to determining the load measurement is outside the accepted variance, accessing purchase history for a user of the cart, wherein the purchase history includes a number of fraudulent anomalies identified for the user; and
responsive to the number of fraudulent anomalies identified for the user exceeding a threshold, identifying the user as fraudulent.

11. A non-transitory computer-readable storage medium comprising stored instructions, which when executed by at least one processor, cause the processor to:
access an image of an item placed inside a cart;
receive an identifier for the item placed inside the cart;
determine a load measurement for the item inside the cart, wherein the load measurement is recorded by a load sensor coupled to the cart and is stored with a timestamp describing when the load measurement was recorded;
encode a feature vector of the item based at least on the determined load measurement, the accessed image, and the received identifier;
input the encoded feature vector to a machine-learning model that is trained to compute a confidence score, the confidence score describing a likelihood that the received identifier matches the item placed inside the cart;
determine that the confidence score is less than a threshold confidence; and
generate a notification alerting an operator of an anomaly in the identifier based on the determination that the confidence score is less than the threshold confidence score.

12. The non-transitory computer-readable storage medium of claim 11, further comprising instructions that cause the processor to:
determine the identifier for the item based on one or more of:
a user input selecting the identifier of the item, wherein the selection of the identifier is made via a graphical user interface on the cart; or
a machine-learning model trained to identify the item by matching the item to a candidate item of a set of candidate items.

13. The non-transitory computer-readable storage medium of claim 11, wherein the instructions for determining the load measurement for the item further comprise instructions that cause the processor to:
determine a timestamp describing when the identifier for the item was determined;
identify a plurality of load measurements recorded by the load sensor within a threshold timeframe of the timestamp describing when the identifier was determined; and
identify a load measurement recorded nearest to the timestamp describing when the identifier for the item was determined based on the timestamp for the identified load measurement.

14. The non-transitory computer-readable storage medium of claim 13, wherein identifiers of multiple items were determined during the threshold timeframe, the instructions further comprising instructions that cause the processor to:
generate a queue of items identified during the threshold timeframe, wherein the queue of items are ordered sequentially based on timestamps when the identifier for each item in the queue was rece;
identify a number of load measurements corresponding to a number of items in the queue; and
assign each of the number of load measurements to an item in the queue sequentially based on the timestamp for the identified load measurement.

15. The non-transitory computer-readable storage medium of claim 11, wherein the instructions for inputting the encoded feature vector to the machine-learning model to determine the confidence score further comprise instructions that cause the processor to:
determine a weight range for the item based on previously recorded load data encoded into the feature vector; and
determine the confidence score based on whether the load measurement falls within the weight range.

16. The non-transitory computer-readable storage medium of claim 11, further comprising instructions that further cause the processor to:
input one or more visual features of the item extracted from the accessed image of the item placed in the cart and one or more known visual features of the item associated with the identifier; and
determine the confidence score based on a comparison of the one or more visual features of the item extracted from the accessed image and one or more known visual features for the item associated with the identifier.

17. The non-transitory computer-readable storage medium of claim 11, further comprising instructions that cause the processor to:
determine an accepted variance in previously recorded load data for the item based on a distribution of the previously recorded load data;
responsive to determining that the confidence score is less than a threshold confidence, compare the load measurement for the item to the accepted variance; and
responsive to determining the load measurement is outside the accepted variance, transmit a notification to an operator identifying the anomaly as fraudulent.

18. The non-transitory computer-readable storage medium of claim 17, further comprising instructions that cause the processor to:
responsive to determining the load measurement is within the accepted variance, transmit a notification to the operator identifying the anomaly as an error.

19. The non-transitory computer-readable storage medium of claim 17, further comprising instructions that cause the processor to:
responsive to determining the load measurement is outside the accepted variance, access purchase history for a user of the cart, wherein the purchase history includes a number of fraudulent anomalies identified for the user; and
responsive to the number of fraudulent anomalies identified for the user exceeding a threshold, identify the user as fraudulent.

20. A system comprising:
at least one processor; and
memory storing non-transitory computer-readable storage instructions, that when executed by at least one processor, cause the at least one processor to:
access an image of an item placed inside a cart;
receive an identifier for the item placed inside the cart;
determine a load measurement for the item inside the cart, wherein the load measurement is recorded by a load sensor coupled to the cart and is stored with a timestamp describing when the measurement was recorded;
encode a feature vector of the item based at least on the determined load measurement, the accessed image, and the determined identifier;
input the encoded feature vector to a machine-learning model that is trained to compute a confidence score, the confidence score describing a likelihood that the received identifier matches the item placed inside the cart;
determine that the confidence score is less than a threshold confidence; and
generate a notification alerting an operator of an anomaly in the identifier based on the determination that the confidence score is less than the threshold confidence score.
